(19) United States
(12) Patent Application Publication
(10) Pub. No.: US 2016/0377056 A1
(43) Pub. Date: Dec. 29, 2016

(54) METHOD AND SYSTEM FOR IMPROVING ENERGY CAPTURE EFFICIENCY FROM AN ENERGY CAPTURE DEVICE

(71) Applicant: SGURRENEGY LIMITED, Glasgow (GB)

(72) Inventor: Ian Irvine, Glasgow (UK)

(21) Appl. No.: 15/121,094

(22) PCT Filed: Feb. 20, 2015
(86) PCT No.: PCT/GB2015/050501

§ 371 Date: Aug. 24, 2016

(30) Foreign Application Priority Data
Feb. 24, 2014 (GB) 1403169.4

(51) Int. Cl. F03D 7/02; G05B 19/402; F03D 17/00; F03B 15/00; F03B 13/26

(52) U.S. Cl. CPC F03D 7/0204; F03B 15/00; F03B 13/26; F03D 17/00; G05B 19/402; F05B 2270/329; F05B 2270/8042; F05B 2270/806; F05B 2270/20; F05B 2220/706; G05B 2219/40242

(57) ABSTRACT

A method and system for improving the efficiency of energy capture from an energy capture device by analysis of the downstream fluid wake created by the energy capture device. In an illustrated embodiment, the system (10) comprises a sensing arrangement (32) configured to acquire air flow data from a downstream wake (34) produced by rotating blades (20) of a wind turbine (12), the sensing arrangement (32) comprising a Lidar unit (35) having an optical source (36) and a receiver (38). In use, the sensing arrangement (32) acquires data relating to the air flow velocity in the wake (34), which data is then processed to determine the relative angle of the wind turbine (12) and the average direction (D) of the incident resource (W).

### REFERENCE TO RELATED APPLICATIONS

This application is a U.S. National Phase application of PCT Application No. PCT/GB2015/050501 filed on Feb. 20, 2015 which claims priority to United Kingdom Application No. 1403169.4 filed on Feb. 24, 2014.

### FIELD OF THE INVENTION

The present invention relates to improving the efficiency of energy capture from an energy capture device. More particularly, but not exclusively, the present invention relates to the correction of yaw misalignment of an energy capture device, such as a wind turbine, tidal turbine or the like.

### BACKGROUND TO THE INVENTION

In recent years, there has been increasing demand for reliable, efficient and cost effective generation of electricity using renewable energy technologies, including offshore and onshore wind.

It is recognized that the efficiency of energy capture from a wind turbine depends on a number of factors, one of which is the relative angle of the wind turbine to the direction of the wind, and that maximum efficiency may not be achieved where the wind turbine rotor is not optimally aligned to the incident resource in respect of yaw angle.

While the yaw angle of modern wind turbines may be adjusted, yaw misalignment is nevertheless a common problem which prevents operation at maximum achievable energy capture.

Correction of wind turbine yaw misalignment requires the ability to measure the wind direction accurately in order for the yaw angle of the wind turbine to be adjusted as required. Conventional techniques rely on wind direction measurements at or in the vicinity of the wind turbine's nacelle. However, conventional measurement techniques are subject to significant inaccuracies. These inaccuracies may, for example, be due to incorrect set-up during the construction and commissioning of the turbine. Conventional techniques also suffer from inaccuracies due to the fact that the measurements are subject to significant flow distortion effects. These inaccuracies can be large, particularly in the case of complex flow behaviour, for example turbulent perturbations.

These inaccuracies can have a significant detrimental effect on the efficiency and consequently the utility of a given wind turbine.

### SUMMARY OF THE INVENTION

Aspects of the present invention relate to a method and system for improving the efficiency of energy capture from an energy capture device by analysis of the downstream fluid wake created by the energy capture device.

More particularly, but not exclusively, aspects of the present invention relate to a method and system for use in the correction of yaw misalignment of an energy capture device, for example, but not exclusively, a wind energy capture device such as a wind turbine or a tidal energy capture device such as tidal turbine, by analysing the downstream fluid wake created by the energy capture device.

According to a first aspect of the present invention, there is provided a method including acquiring fluid flow data from a downstream fluid wake produced by an energy capture device, and providing an output value from the acquired data which is indicative of the yaw angle of the energy capture device relative to the direction of fluid flow impinging on the energy capture device.

Operating wind turbines extract energy from the air flow, and as a result create a downstream “wake” within which the airflow has reduced velocity and increased turbulence. Accurate measurement of this wake has, historically, been difficult to achieve given the limitations of anemometers and wind vanes which, individually, only measure wind speed and direction at a single point. Embodiments of the present invention beneficially overcome or at least mitigate the drawbacks associated with conventional techniques for improving efficiency of energy capture and/or correcting yaw misalignment by measuring the characteristics of the wake behind the energy capture device. For example, in embodiments where the energy capture device includes a wind energy capture device such as a wind turbine, it is possible to establish whether or not the turbine rotor is fully aligned, that is perpendicular, to the air flow.

A sensing arrangement may be located on the energy capture device. Alternatively, or additionally, part or all of the sensing arrangement may be disposed at a remote location. The sensing arrangement may be positioned at any other suitable location capable of sensing the wake. The sensing arrangement may be disposed on the ground. The sensing arrangement may be disposed on a platform, such as an offshore platform or the like. The sensing arrangement may be disposed on another energy capture device.

The method may include scanning the downstream wake from the energy capture device using the sensing arrangement.

The method may include measuring and/or mapping the shape of the wake.

The method may include measuring and/or mapping the intensity of the wake.

The fluid flow data may include fluid velocity data. For example, in particular embodiments the energy capture device may include a wind energy capture device and the fluid flow data may include air velocity data. In other embodiments, the energy capture device may include a tidal energy capture device and the fluid flow data may include water velocity data.

The fluid flow data may include fluid positional and/or directional data relative to an axis of the energy capture device. The fluid flow data may include data relating to the azimuth of the fluid relative to the axis of the energy capture device.

The method may include acquiring fluid flow velocity data and fluid positional data from the wake.

The method may include determining a core of the wake from the acquired fluid flow data, the positioning and/or behaviour of the core of the wake corresponding to the direction of fluid flow impinging on the energy capture device.

The method may include plotting the fluid flow data to determine a core of the wake, the core of the wake corresponding to the direction of fluid flow impinging on the energy capture device.

The method may include plotting the fluid flow velocity data against the fluid positional data relative to the axis of the energy capture device to determine the core of the wake.

In particular embodiments, the method may include plotting the fluid flow data from a cross section of the wake to determine the core of the wake.

The core of the wake may include the position relative to the axis of the energy capture device having lowest average flow velocity. For example, when plotting a curve of the position of the core of the wake on a graph of flow velocity relative to position relative to the axis of the energy capture device, the core of the wake may define a minimum value for the acquired data.

Beneficially, the ability to identify the core of the wake, in particular the position of the core of the wake relative to the axis of the energy capture device, permits an accurate indication of the true direction of fluid flow impinging on the energy capture device. For example, in embodiments where the energy capture device includes a wind energy capture device such as a wind turbine, identifying the position or azimuth of the core of the wake relative to the axis of the turbine permits optimal alignment of the rotor to the incident resource in respect of yaw angle.

Acquiring the fluid flow data may be achieved by any suitable means.

The fluid flow data may be acquired remotely.

The fluid flow data may be acquired by a remote sensing arrangement.

The fluid flow data may be acquired across a three-dimensional flow field.

Beneficially, the ability of acquire the data across a three-dimensional flow field permits the complex air flows produced by the energy capture device to be mapped with a high degree of precision and across a wide area.

In particular embodiments, the sensing arrangement may include a Lidar sensing arrangement.

Beneficially, a Lidar sensing arrangement, which uses a light source or laser to measure air flow velocity across a three-dimensional flow field, permits measurement of complex air flows across wide areas. Accordingly, by using a Lidar sensing arrangement to measure the shape and intensity of the wake it is possible to establish whether or not the turbine is optimally aligned (for example but not exclusively perpendicular) to the incident resource as it passes through the rotor disc.

Alternatively, the sensing arrangement may include a Sodar sensing arrangement. A Sodar sensing arrangement, which uses a sound source to measure flow velocity across a three-dimensional flow field, permits measurement of complex water flows across wide areas. By using a Sodar sensing arrangement to measure the shape and intensity of the wake it is possible to establish whether or not the turbine is optimally aligned (for example but not exclusively perpendicular) to the incident resource as it passes through the rotor disc.

The method may include adjusting the yaw angle of the energy capture device.

In particular, the method may include adjusting the yaw angle of the energy capture device so that the core of the wake corresponds to the axis of the energy capture device.

By reducing or eliminating the yaw angle between the energy capture device and the incident resource impinging on the energy capture device, yaw misalignment may be reduced or eliminated and the efficiency of energy extraction and electricity generation may be maximized or at least improved.

The output value may be communicated to the control system. For example, the output value may be communicated directly to the control system so that the control system adjusts the position of the energy capture device in real time, at a predetermined time threshold, or when the yaw angle of the energy capture device relative to the direction of the fluid impinging on the energy capture device exceeds a particular threshold.

Alternatively, or additionally, the method may include communicating the output value to a remote location, such as to an operator, control centre or the like.

According to a second aspect of the present invention, there is provided a system including a sensing arrangement configured to acquire fluid flow data from a downstream wake of an energy capture device, and a communication arrangement for providing an output value indicative of the difference between the average direction of an incident resource and the angle of the energy capture device.

The sensing arrangement may be mounted or otherwise positioned on the energy capture device.

The energy capture device may include a rotor. The energy capture device may include a plurality of blades.

The energy capture device may include a nacelle.

The sensing arrangement may be disposed on a nacelle of the energy capture device.

The sensing arrangement may be configured to scan the wake from the energy capture device.

The reference point is at or near to the turbine axis/nacelle axis.

The energy capture device may be of any suitable form and construction.

In particular embodiments, the energy capture device may include a wind energy extraction device, such as a wind turbine or the like.

The sensing arrangement may be of any suitable form and construction.

The sensing arrangement may include a remote sensing arrangement.

The sensing arrangement may be configured to measure fluid flow velocity, such as airflow velocity, across a three-dimensional flow field.

In particular embodiment, the sensing arrangement may include a Lidar sensing arrangement.

Alternatively, the sensing arrangement may include a Sodar sensing arrangement.

The system may include a control system.

The control system may be configured to adjust the position, for example the yaw angle, of the energy capture device.

The communication arrangement may be of any suitable form and construction.

The communication arrangement may be configured to transmit the output value to the control system.

Alternatively, or additionally, the communication arrangement may be configured to transmit the output value to a remote location.

It should be understood that the features defined above in accordance with any aspect of the present invention or below in relation to any specific embodiment of the invention may be utlilzed, either alone or in combination with any other defined feature, in any other aspect or embodiment of the invention.

### BRIEF DESCRIPTION OF THE DRAWINGS

These and other aspects of the present invention will now be described, by way of example only, with reference to the accompanying drawings, in which:

FIG. 1 is a diagrammatic view of a wind turbine system according to an embodiment of the present invention;

FIG. 2 shows a sensing arrangement for use in the present invention;

FIG. 3 is a diagrammatic plan view of the wind turbine system shown in FIG. 1, in a first position;

FIG. 4 is a graph showing a plot of wind speed against azimuth for the wind turbine system in the first position shown in FIG. 3;

FIG. 5 is a diagrammatic plan view of the wind turbine system shown in FIG. 1, in a second position;

FIG. 6 is a graph showing a plot of wind speed against azimuth for the wind turbine system in the second position shown in FIG. 5.

FIG. 7 is a diagrammatic view of a tidal turbine system according to another embodiment of the present invention;

FIG. 8 shows a sensing arrangement for use in the present invention;

FIG. 9 is a diagrammatic plan view of the tidal turbine system shown in FIG. 7, in a first position;

FIG. 10 is a graph showing a plot of water speed against azimuth for the tidal turbine system in the first position shown in FIG. 9;

FIG. 11 is a diagrammatic plan view of the tidal turbine system shown in FIG. 7, in a second position;

FIG. 12 is a graph showing a plot of water speed against azimuth for the tidal turbine system in the second position shown in FIG. 11; and

FIG. 13 is a diagrammatic view of a turbine system according to another embodiment of the present invention.

### DETAILED DESCRIPTION OF THE DRAWINGS

Referring first to FIG. 1, there is shown a diagrammatic perspective view of a system 10 according to an embodiment of the present invention.

In the illustrated embodiment, the system 10 includes a wind turbine system. However, it will be recognized that the system 10 may take other forms and may, for example, include a tidal energy capture turbine system or the like.

As shown in FIG. 1, the wind turbine system 10 includes a wind turbine 12 having a tower 14, a nacelle 16 and a hub 18 having a plurality of radially extending blades 20. The hub 18 is operatively coupled to an electrical generator 22 via a drive shaft 24. In the illustrated embodiment, a gear arrangement 26 in the form of a gear box is provided, although in other embodiments, a gear arrangement may not be provided. In the illustrated embodiment, the turbine 12 further includes a controller 28, the controller 28 operatively coupled to a yaw drive arrangement 30 capable of adjusting the angle of the turbine 12.

In use, the kinetic energy of wind W impinging on the blades 20 drives rotation of the hub 18 relative to the nacelle 16, the kinetic energy being transmitted via the drive shaft 24 (and the gear arrangement 26 where provided) to the electrical generator 22, where it is converted into electricity.

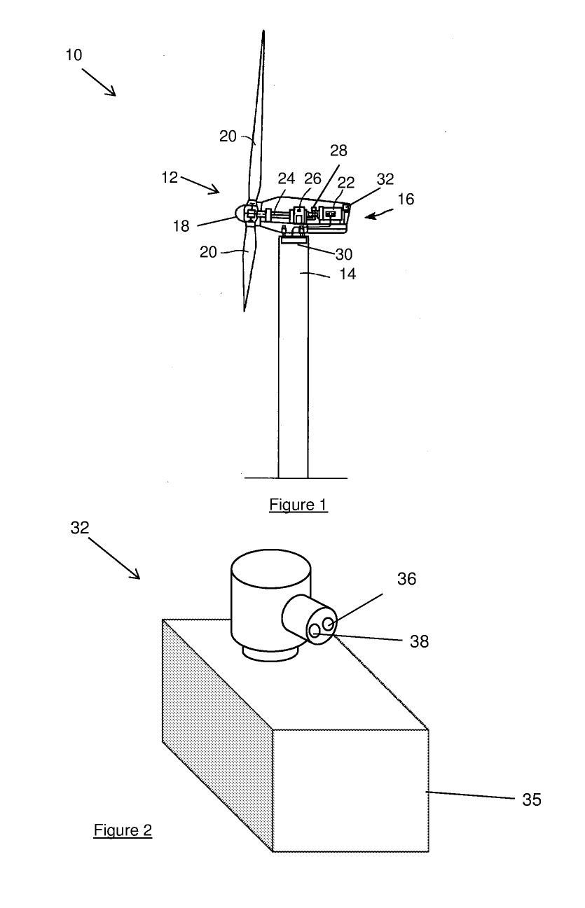

As shown in FIG. 1 and with reference also to FIG. 2, the system 10 further includes a sensing arrangement 32 which, in the illustrated embodiment, is disposed on the nacelle 16 of the wind turbine 12. It will be recognized, however, that the sensing arrangement 32 may be provided at other suitable locations, such as a remote location, a platform, on the ground or on one or more other turbine.

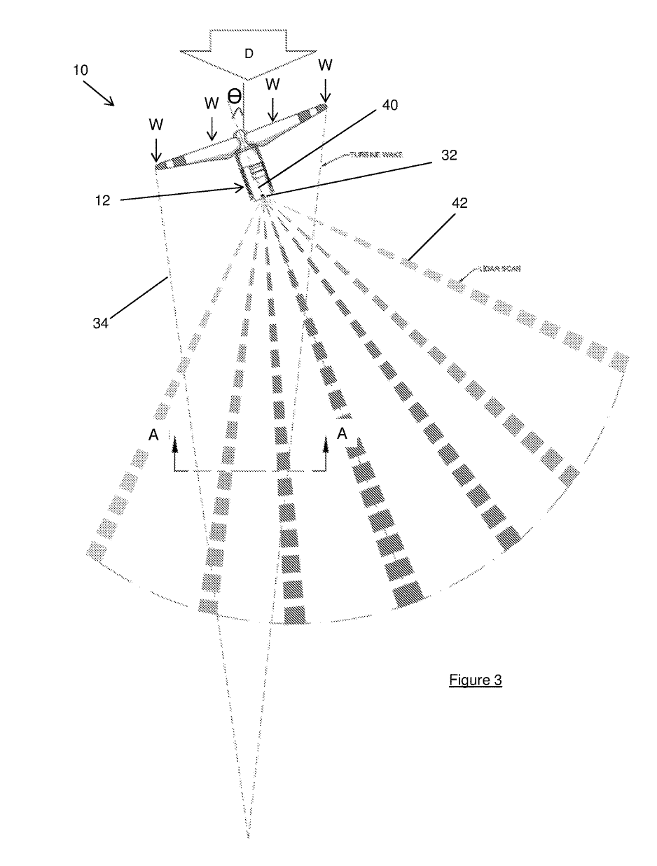

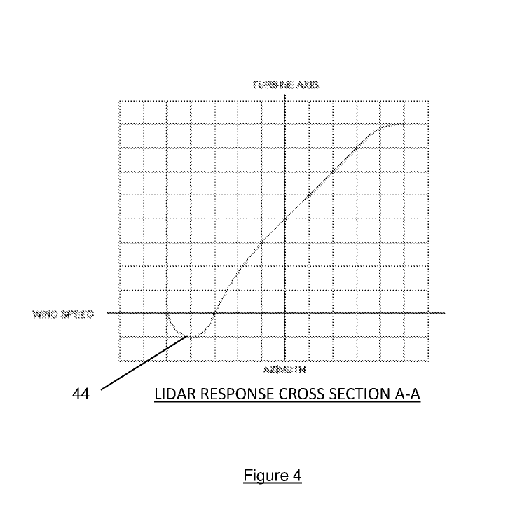

In use, and referring also to FIG. 3 which shows a diagrammatic plan view of the wind turbine system 10 in a first position, the sensing arrangement 32 is configured to acquire air flow data from a downstream wake 34 produced by the rotating blades 20 of the wind turbine 12. In the illustrated embodiment, the sensing arrangement 32 includes a Lidar unit 35 having an optical source 36—in the illustrated embodiment a laser source—for transmitting light beams over the desired flow field, which in embodiments of the invention includes the downstream fluid wake 34 produced by the blades 20. The unit 35 further includes or is operatively associated with a receiver 38—in the illustrated embodiment an optical antenna for detecting the light reflected back from the wake 34. In the illustrated embodiment, this is achieved by measuring the back-scatter of light radiation which is reflected by natural aerosols carried by the wind, such as dust, water droplets, pollution, pollen, salt crystals or the like.

In use, the sensing arrangement 32 acquires data relating to the air flow velocity in the wake 34 across a three-dimensional flow field, which data is then processed to determine the relative angle of the wind turbine 12 and the average direction D of the incident resource W.

To illustrate the system and method of the present invention, operation of the wind turbine system 10 will now be described with reference to FIGS. 3 to 6.

As described above, FIG. 3 shows a plan view of the wind turbine system 10 in a first position, in which the wind turbine 12 is positioned at an angle θ to the average direction D of the wind W.

The sensing arrangement 32 is positioned at, or calibrated to, the rotational axis 40 of the turbine 12 and, in use, the sensing arrangement 32 acquires wind speed and azimuth data relative to the turbine axis 32 by scanning a three-dimensional field which includes the wake 34 produced by the blades 20 of the turbine 12, in the illustrated embodiment the scan represented by reference numeral 42.

A graph showing a plot of the acquired wind speed and azimuth data for cross section A-A of wake 34 when the turbine 12 is in the first position is shown in FIG. 4. As can be seen from FIGS. 3 and 4, the wake 34 produced by the blades 20 of the turbine 12 is deflected and a core 44 of the wake 34—as represented in the graph by the lowest point—is out of alignment with the rotational axis 40 of the turbine 12, the azimuth a of the core 44 relative to the turbine rotational axis 40 corresponding to the misalignment of the turbine 12 relative to the average direction of the incident resource D.

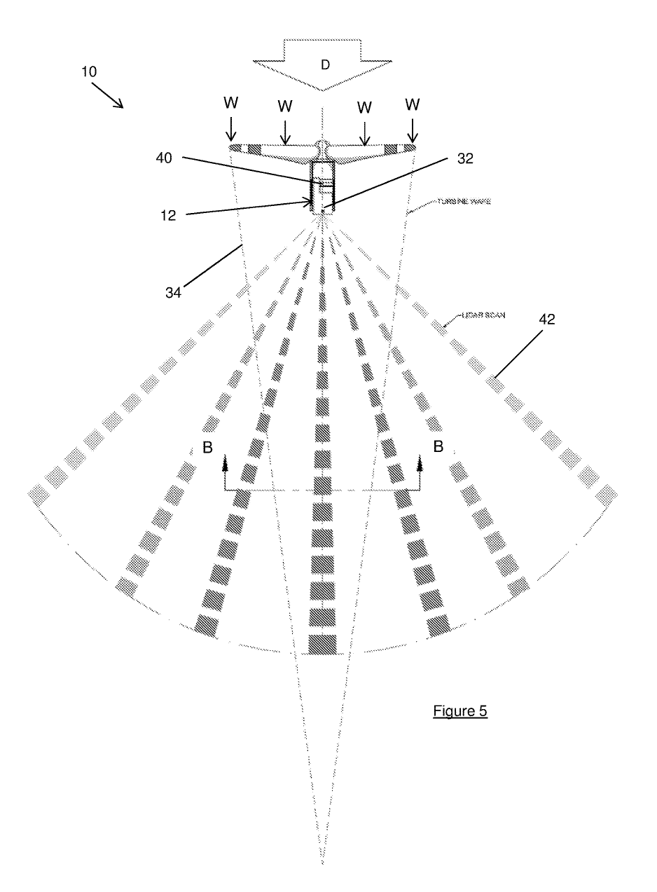

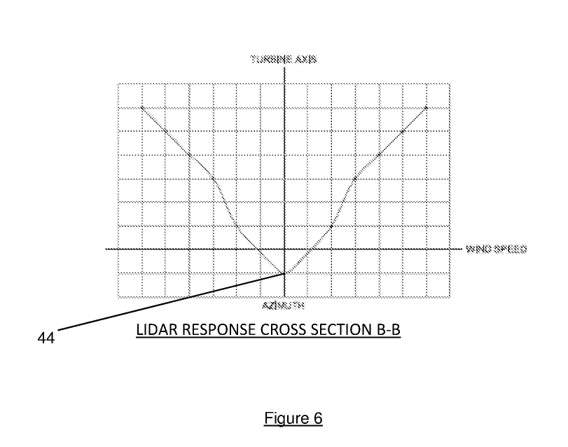

In this way, an output indicative of the misalignment of the turbine 12 relative to the wind direction D may be produced, which may be communicated to an operator or communicated directly to the control system where it may be used to alter the angle of the turbine 12 from the position shown in FIG. 3 to the position shown in FIG. 5.

FIG. 5 shows a plan view of the wind turbine system 10 in the second position, in which the wind turbine 12 is positioned in exact alignment with the rotational axis 40 of the turbine 12 and FIG. 6 shows a graph showing a plot of the acquired wind speed and azimuth data for cross section B-B of wake 34 when the turbine 12 is in the second position. As can be seen from FIGS. 5 and 6, the wake 34 produced by the blades 20 of the turbine 12 is symmetrical about the turbine rotational axis 40 and the core 44 of the wake 34—as represented in the graph by the lowest point—is aligned with the rotational axis 40 of the turbine 12.

By utilizing the method and system of the present invention, it is possible to establish the correct yaw alignment with a high degree of accuracy and thereby maximise turbine efficiency and energy production.

It should be understood that the embodiments described herein are merely exemplary and that various modifications may be made thereto without departing from the scope of the invention.

For example, whereas the particular embodiment described above relates to a wind energy capture system using a Lidar sensing arrangement, other embodiments of the invention may take other forms.

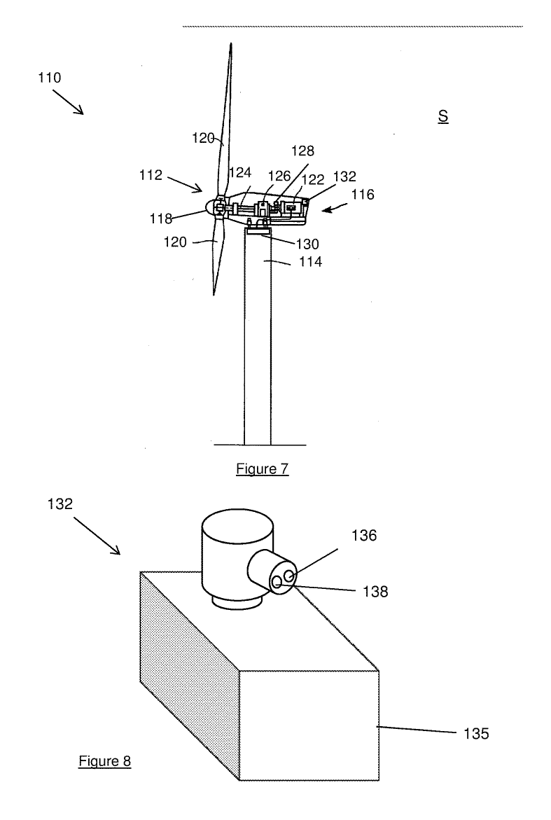

Referring now to FIGS. 7 to 12, there is shown a system 110 according to an alternative embodiment of the invention. The system 110 includes a tidal energy capture system for location in a body of water S and which utilise a Sodar (Sound Detection and Ranging) sensing arrangement, although it will be recognized that other sensing arrangements may be used where appropriate.

As shown in FIG. 7, the tidal turbine system 110 includes a tidal turbine 112 having a tower 114, a nacelle 116 and a hub 118 having a plurality of radially extending blades 120. The hub 118 is operatively coupled to an electrical generator 122 via a drive shaft 124. In the illustrated embodiment, a gear arrangement 126 in the form of a gear box is provided, although in other embodiments a gear arrangement may not be provided. In the illustrated embodiment, the turbine 112 further includes a controller 128, the controller 128 operatively coupled to a yaw drive arrangement 130 capable of adjusting the angle of the turbine 112 in the body of water.

In use, the kinetic energy of water impinging on the blades 120 drives rotation of the hub 118 relative to the nacelle 116, this kinetic energy being transmitted via the drive shaft 124 (and the gear arrangement 126 where provided) to the electrical generator 122 where it is converted into electricity.

As shown in FIG. 7 and with reference also to FIG. 8, the system 110 further includes a sensing arrangement 132 which, in the illustrated embodiment, is disposed on the nacelle 116 of the tidal turbine 112. It will be recognized, however, that the sensing arrangement 132 may be provided at other suitable locations, such as a remote location, a platform, on the seabed or on one or more other turbine.

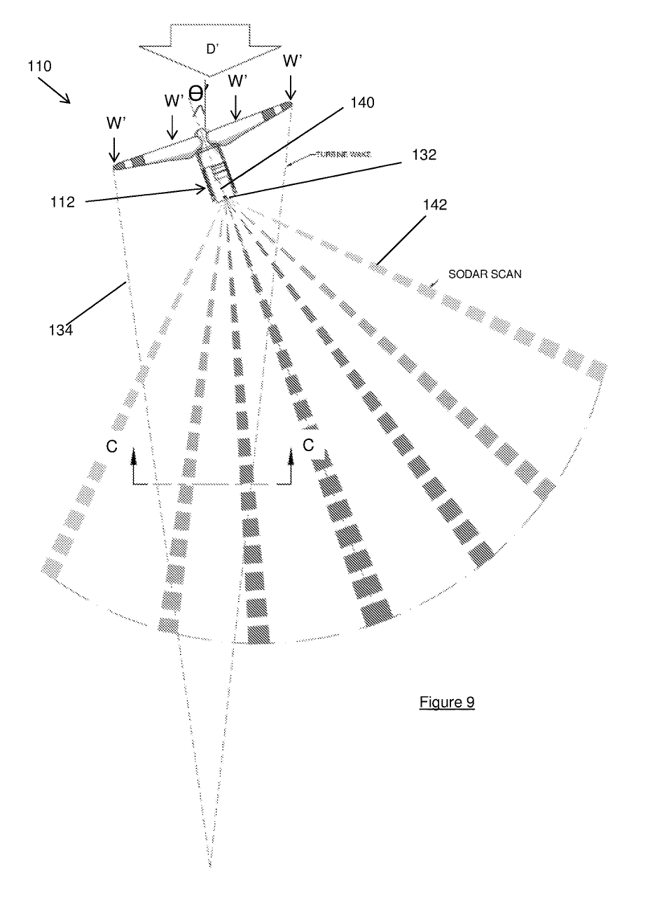

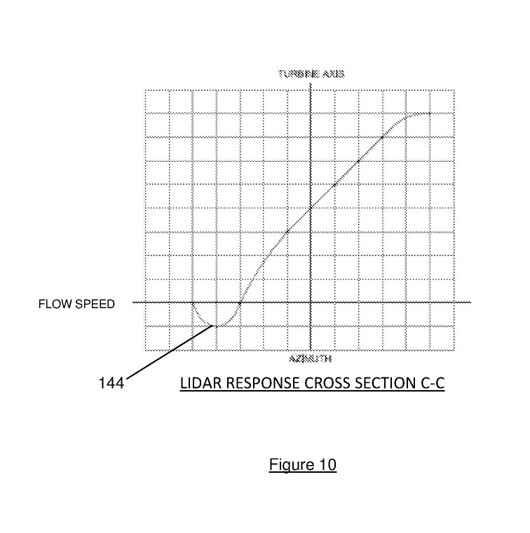

In use, and referring also to FIG. 9 which shows a diagrammatic plan view of the tidal turbine system 110 in a first position, the sensing arrangement 132 is configured to acquire flow data from a downstream wake 134 produced by the rotating blades 120 of the tidal turbine 112. In the illustrated embodiment, the sensing arrangement 132 includes a Sodar unit 135 having a sound source 136 for transmitting sound pulses over the desired flow field, which in embodiments of the invention includes the downstream fluid wake 134 produced by the blades 120. The unit 135 further includes or is operatively associated with a receiver 138 for detecting the sound reflected back from the wake 134.

In the illustrated embodiment, this is achieved by emitting a short pulse of sound at a certain frequency. The sound propagates outwards and upwards, while at the same time a part of the sound is reflected back. The Doppler frequency shift of the received signal is proportional to the fluid speed aligned to the transmission sound path. By combining three or five of these pulses, for example one along the vertical and two or four inclined to the vertical, the three-dimensional velocity field of both the mean values and the turbulent values is calculated.

In use, the sensing arrangement 132 acquires data relating to the flow velocity in the wake 134 across a three-dimensional flow field, which data is then processed to determine the relative angle of the wind turbine 112 and the average direction D′ of the incident resource W′.

To illustrate the system and method of the present invention, operation of the wind turbine system 110 will now be described with reference to FIGS. 9 to 12.

As described above, FIG. 9 shows a plan view of the tidal turbine system 110 in a first position, in which the tidal turbine 12 is positioned at an angle θ′ to the average direction D′ of the incident resource W′.

The sensing arrangement 132 is positioned at, or calibrated to, the rotational axis 140 of the turbine 112 and, in use, the sensing arrangement 132 acquires flow speed and azimuth data relative to the turbine axis 132 by scanning a three-dimensional field which includes the wake 134 produced by the blades 120 of the turbine 112, in the illustrated embodiment the scan represented by reference numeral 142.

A graph showing a plot of the acquired flow speed and azimuth data for cross section C-C of wake 134 when the turbine 112 is in the first position is shown in FIG. 10. As can be seen from FIGS. 9 and 10, the wake 134 produced by the blades 120 of the turbine 112 is deflected and a core 144 of the wake 134—as represented in the graph by the lowest point—is out of alignment with the rotational axis 40 of the turbine 112, the azimuth α′ of the core 144 relative to the turbine rotational axis 140 corresponding to the misalignment of the turbine 112 relative to the average direction of the incident resource D′.

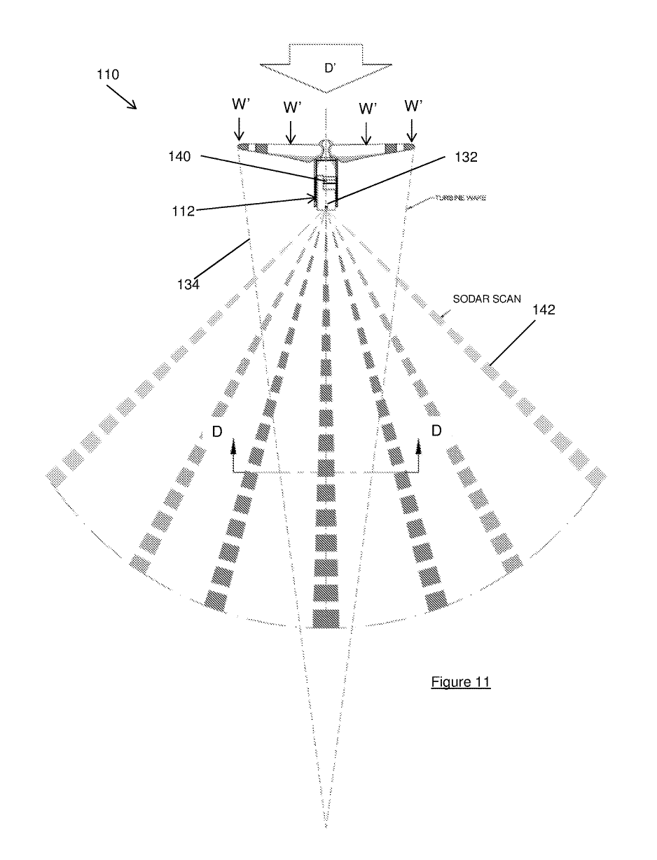

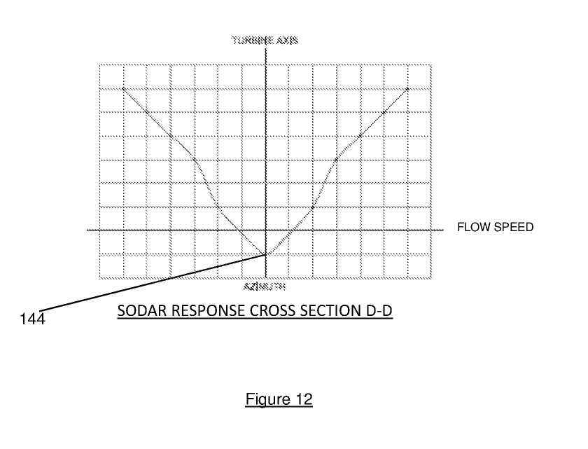

In this way, an output indicative of the misalignment of the turbine 112 relative to the flow direction D may be produced, which may be communicated to an operator or communicated directly to the control system where it may be used to alter the angle of the turbine 112 from the position shown in FIG. 9 to the position shown in FIG. 11.

FIG. 9 shows a plan view of the tidal turbine system 110 in the second position, in which the tidal turbine 112 is positioned in exact alignment with the rotational axis 140 of the turbine 112 and FIG. 12 shows a graph showing a plot of the acquired flow speed and azimuth data for cross section D-D of wake 134 when the turbine 112 is in the second position. As can be seen from FIGS. 11 and 12, the wake 134 produced by the blades 120 of the turbine 112 is symmetrical about the turbine rotational axis 140 and the core 144 of the wake 134—as represented in the graph by the lowest point—is aligned with the rotational axis 140 of the turbine 112.

Whereas in the embodiments described above, the sensing arrangement is disposed on the turbine, it will be recognized that the sensing arrangement may be positioned at any other suitable location capable of sensing the wake.

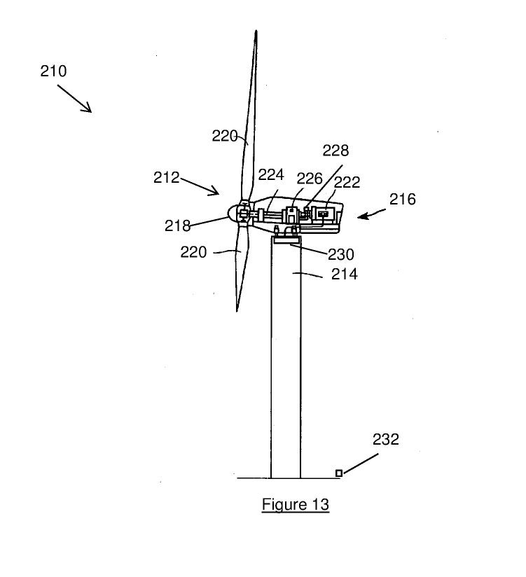

Referring now to FIG. 13, there is shown a system 210 according to an alternative embodiment of the invention. The system 210 is similar to the systems 10, 110 described above with the difference that the sensing arrangement 232 is located on the ground.

As shown in FIG. 13, the turbine system 210 includes a turbine 212 having a tower 214, a nacelle 216 and a hub 218 having a plurality of radially extending blades 220. The hub 218 is operatively coupled to an electrical generator 222 via a drive shaft 224. In the illustrated embodiment, a gear arrangement 226 in the form of a gear box is provided, although in other embodiments a gear arrangement may not be provided. In the illustrated embodiment, the turbine 212 further includes a controller 228, the controller 228 operatively coupled to a yaw drive arrangement 230 capable of adjusting the angle of the turbine 212.

In use, the kinetic energy of incident resource (for example air or water) on the blades 220 drives rotation of the hub 218 relative to the nacelle 216, this kinetic energy being transmitted via the drive shaft 224 (and the gear arrangement 226 where provided) to the electrical generator 222 where it is converted into electricity.

As described above, in this embodiment the sensing arrangement 232 is disposed on the ground and is configured to acquire flow data from a downstream wake 234 produced by the rotating blades 220 of the turbine 212. The sensing arrangement 232 itself may be of any suitable form and may, for example include a Lidar sensing arrangement such as the sensing arrangement 32 described above or a Sodar sensing arrangement such as the sensing arrangement 132 described above.

It will be recognized that the method and system of the present invention may be used in number of different ways and at different instances during the working life of the energy capture device. For example, the technique may involve short-term application of the sensing arrangement, after which the alignment may be corrected and the sensing arrangement is removed to be used elsewhere. Alternatively, the sensing arrangement may be left in-situ for continuous application.

1. A method comprising the steps of:
acquiring fluid flow data from a downstream fluid wake produced by an energy capture device; and
providing an output value from the acquired fluid flow data which is indicative of yaw angle of the energy capture device relative to a direction of fluid flow impinging on the energy capture device.

2. The method of claim 1, comprising the steps of scanning the downstream fluid wake from the energy capture device using a remote sensing arrangement.

3. The method of claim 1, comprising the steps of measuring and/or mapping at least one of: a shape and an intensity of the wake.

4. (canceled)

5. The method of claim 1, wherein the fluid flow data comprises at least one of: fluid velocity data, air velocity data, fluid positional data and/or directional data relative to an axis of the energy capture device data relating to the azimuth of the fluid relative to the axis of the energy capture device.

6-9. (canceled)

10. The method of claim 1, comprising the step of determining a core of the wake from the acquired fluid flow data.

11. The method of claim 10, comprising the steps of:
plotting the fluid flow data to determine the core of the wake, wherein the step of plotting the fluid flow data comprises at least one of:
plotting the fluid velocity data against the fluid positional data relative to the axis of the energy capture device to determine the core of the wake; and
plotting the fluid flow data from a cross section of the wake to determine the core of the wake.

12-15. (canceled)

16. The method of claim 1, wherein the fluid flow data is acquired across a three-dimensional flow field.

17. The method of claim 1, wherein the sensing arrangement comprises a Lidar sensing arrangement.

18. The method of claim 1, wherein the sensing arrangement comprises a Sodar sensing arrangement.

19. The method of claim 1, comprising the step of adjusting the yaw angle of the energy capture device.

20. (canceled)

21. The method of claim 1, comprising the step of communicating the output value to a control system.

22. (canceled)

23. The method of claim 21, comprising the step of communicating the output directly to the control system so that the control system adjusts the position of the energy capture devices., in real time, at a predetermined time threshold, and/or when the yaw angle of the energy capture device relative to the direction of the fluid impinging on the energy capture device exceeds a particular threshold.

24-25. (canceled)

26. The method of claim 1, comprising the step of communicating the output value to a remote location.

27. A system comprising:
a sensing arrangement configured to acquire fluid flow data from a downstream wake of an energy capture device; and
a communication arrangement for providing an output value indicative of a difference between an average direction of an incident resource and an angle of the energy capture device.

28. The system of claim 27, wherein the sensing arrangement is mounted on the energy capture device.

29. The system of claim 27, wherein the sensing arrangement is configured to scan the wake from the energy capture device.

30. The system of claim 27, wherein the energy capture device comprises a wind energy extraction device.

31. The system of claim 27, wherein the energy capture device comprises a tidal energy extraction device.

32. The system of claim 27, wherein the sensing arrangement comprises a remote sensing arrangement.

33. The system of claim 27, wherein at least one of:
the sensing arrangement is configured to measure fluid flow velocity, and
the sensing arrangement is configured to measure the fluid flow velocity across a three-dimensional flow field.

34. (canceled)

35. The system of claim 27, wherein the sensing arrangement comprises a Lidar sensing arrangement.

36. The system of claim 27, wherein wherein the sensing arrangement comprises a Sodar sensing arrangement.

37. The system of claim 27, comprising a control system configured to adjust the position of the energy capture device.

38-40. (canceled)
